(19) United States
(12) Patent Application Publication
(10) Pub. No.: US 2014/0358778 A1
(43) Pub. Date: Dec. 4, 2014

(54) MULTI-LEVEL KNOW YOUR CUSTOMER (KYC) DATA COLLECTION AND VERIFICATION

(71) Applicant: IDMission LLC, Boulder, CO (US)

(72) Inventors: Ashim Banerjee, Boulder, CO (US); Sandeep Gandhi, San Ramon, CA (US); Angela Schmuck, Mesa, AZ (US)

(21) Appl. No.: 13/907,306

(22) Filed: May 31, 2013

(51) Int. Cl. G06Q 20/40

(52) U.S. Cl. CPC G06Q 20/4014
USPC 705/44

(57) ABSTRACT

Systems, devices, and methods for transaction processing are provided. A point-of-transaction device transmits a transaction request to a transaction information server. The transaction information server receives the transaction request, queries one or more storage records to confirm the identity of the customer to the transaction and to determine whether the customer is authorized to engage in the transaction. The transaction information server further establishes a record that ties the customer's identity to the transaction. If so, the transaction information server establishes a transaction identifier code and communicates the code to the point-of-transaction device. The point-of-transaction device communicates the transaction identifier code and at least a portion of the transaction request to a transaction authority. The transaction authority transmits a confirmation signal to the point-of-transaction device based on the transaction identifier code and the transaction request.

### BACKGROUND

The present invention relates to transaction processing systems and methods that integrate a customer's identity into the transaction as well as verifying the customer's identity contemporaneous to the transaction.

Transactions are an integral component of virtually every economy. Exemplary transactions may include, but are not limited to, money transfers, deposits, prepaid cards, mobile connections, etc. For each transaction, the user (e.g., agent, retailer, bank, service provider, etc.) can be faced with competing interests. On one hand, there is a need for the user to provide a satisfactory experience for the customer. On the other hand, financial considerations and legal requirements favor the prevention of fraud, identity theft, money laundering, and the like when conducting transactions.

For some transactions (e.g., cash-based transactions), proof of identity for the customer is not always requested. For other transactions where identification of the customer is requested, the identity of the customer is not always confirmed. Furthermore, it is common that the identity of the customer is not associated or otherwise tied intrinsically with the transaction. By way of example, the user may request and be presented with a proof of identification from the customer during a transaction. Typically, the user may confirm that the proof of identification corresponds to the customer, e.g., is the same name as appears on a credit card provided by the customer. However, the user typically has no way of confirming that the proof of identification provided by the customer is authentic.

Thus, there is a need to confirm the identification of a user of a transaction and further to associate the customer identification with the transaction.

### SUMMARY

In one set of illustrative embodiments, a method of conducting a transaction includes receiving, at a transaction information server, a request for a transaction from a point of transaction device, the request comprising a transaction amount, a customer identifier code, and an identification parameter that is collected from a party to the transaction contemporaneous to the transaction; authenticating the identification parameter based on a record associated with the customer identifier code stored by the transaction information server; communicating with a transaction authority to establish a transaction identifier code for the transaction based on the authentication of the identification parameter; and transmitting the transaction identifier code to the point of transaction device based on the authentication of the identification parameter.

In a second set of illustrative embodiments, a method for conducting a transaction may include transmitting, from a point of transaction device, a request for a transaction to a transaction information server, the request comprising a transaction amount, a customer identifier code, and an identification parameter that is collected from a party to the transaction contemporaneous to the transaction; receiving, from the transaction information server, a transaction identifier code based on an authentication of the identification parameter; transmitting the transaction identifier code and at least a portion of the request for the transaction to a transaction authority separate from the transaction information server; and receiving an approval for the transaction from the transaction authority, the approval based on the transaction identifier code and the request.

In a third set of illustrative embodiments, an apparatus for conducting a transaction may include at least: a processor; a memory in electronic communication with the processor; and instructions being executable by the processor to, receive, at a transaction information server, a request for a transaction from a point of transaction device, the request comprising a transaction amount, a customer identifier code, and an identification parameter that is collected from a party to the transaction contemporaneous to the transaction; authenticate the identification parameter based on a record associated with the customer identifier code stored by the transaction information server; communicate with a transaction authority to establish a transaction identifier code for the transaction based on the authentication of the identification parameter; and transmit the transaction identifier code to the point of transaction device based on the authentication of the identification parameter.

In a fourth set of illustrative embodiments, an apparatus for conducting a transaction may include at least: a processor; a memory in electronic communication with the processor; and instructions being executable by the processor to, transmit, from a point of transaction device, a request for a transaction to a transaction information server, the request comprising a transaction amount, a customer identifier code, and an identification parameter that is collected from a party to the transaction contemporaneous to the transaction; receive, from the transaction information server, a transaction identifier code based on an authentication of the identification parameter; transmit the transaction identifier code and at least a portion of the request for the transaction to a transaction authority separate from the transaction information server; and receive an approval for the transaction from the transaction authority, the approval based on the transaction identifier code and the request.

In a fifth set of illustrative embodiments, a system for conducting a transaction may include at least: a point of transaction device configured to transmit a request for a transaction, the request comprising a transaction amount, a customer identifier code, and an identification parameter that is collected from a party to the transaction contemporaneous to the transaction; and a transaction information server in communication with the point of transaction device to receive the request, authenticate the identification parameter based on a record associated with the customer identifier code, communicate with a transaction authority to establish a transaction identifier code for the transaction, and transmit the transaction identifier code to the point of transaction device.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIG. 2 is a diagram illustrating an exemplary communication flow between components configured according to various embodiments of the invention.

FIG. 3 is a diagram of another exemplary communication flow between components configured according to various embodiments of the invention.

FIG. 4 is a diagram of another exemplary communication flow between components configured according to various embodiments of the invention.

FIG. 5 is a diagram of another exemplary communication flow between components configured according to various embodiments of the invention.

FIG. 6 is a diagram of another exemplary communication flow between components configured according to various embodiments of the invention.

FIG. 7 is a block diagram of an example of a transaction information server according to various embodiments of the invention.

FIG. 8 a block diagram of an example of another transaction information server according to various embodiments of the invention.

FIG. 9 is a block diagram of an example of a point-of transaction device according to various embodiments of the invention.

FIG. 10 is a block diagram of another example of a point-of-transaction device according to various embodiments of the invention.

FIG. 11 is a flowchart diagram of an example method of conducting a transaction according to various embodiments of the invention.

FIG. 12 is a flowchart diagram of another example method of conducting a transaction according to various embodiments of the invention.

FIG. 13 is a schematic diagram that illustrates a representative device structure that may be used in various embodiments of the present invention.

### DETAILED DESCRIPTION OF THE INVENTION

Methods, systems, and devices are disclosed for conducting a transaction that authenticates the identification of the customer and also intrinsically ties the customer identity with the transaction. A transaction information server may be in communication with one or more Point-of-Transaction devices. The point-of-transaction devices can be located proximate to a user and configured to transmit a request for a transaction to the transaction information server. In one example, the point-of-transaction device is configured to permit the user to capture an identification parameter from a customer during the transaction, e.g., an image of an identification card provided by the customer, biometric data associated with the customer, etc. The point-of-transaction device can transmit the identification parameter, along with other associated transaction parameters, to the transaction information server. The transaction information server may utilize the identification parameter along with additional customer identifier data to confirm the identity of the party. According to some embodiments, the transaction information server may communicate with a transaction authority to obtain or establish a transaction identifier code that is associated with the transaction and then return the transaction identifier code to the point-of-transaction device. The user may then submit a request to the transaction authority with the associated transaction identifier code to receive a final authorization for the transaction. According to certain aspects, the transaction is a cash-based transaction.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

As used herein, the terms “user(s)” and “customer(s)” generally refer to the parties to a transaction. By way of example only, a user may be an individual, an agent, a bank teller, a service provider, a brick-and-mortar business, etc. In some situations, the user may be the party to the transaction that provides certain goods and/or services being exchanged during the transaction. The customer may be an individual, representative of a company, a group of individuals, etc. In some situations, the customer is the party to the transaction that seeks to receive the goods and/or services being provided by the user. According to one example, the user may be an agent at a money transfer business where the customer is an individual seeking to transfer money. According to another example, the user may be an agent of a government agency charged with distributing government subsidies where the customer is an individual seeking to receive the subsidies.

As used herein, the term “transaction” refers to any exchange between a user and a customer. The transaction may be monetary or non-monetary based. The transaction may be for money, for services, for information, etc. According to some examples, the transaction may be a one-way transaction, e.g., a money transfer exchange where the customer provides money to an agent to be transferred to a different location. In that instance, a second user and customer may complete another transaction at the remote location. Furthermore, a transaction is not limited to a single user and/or a single customer.

Systems, devices, methods, and software are described for transaction processing in a system of networked devices.

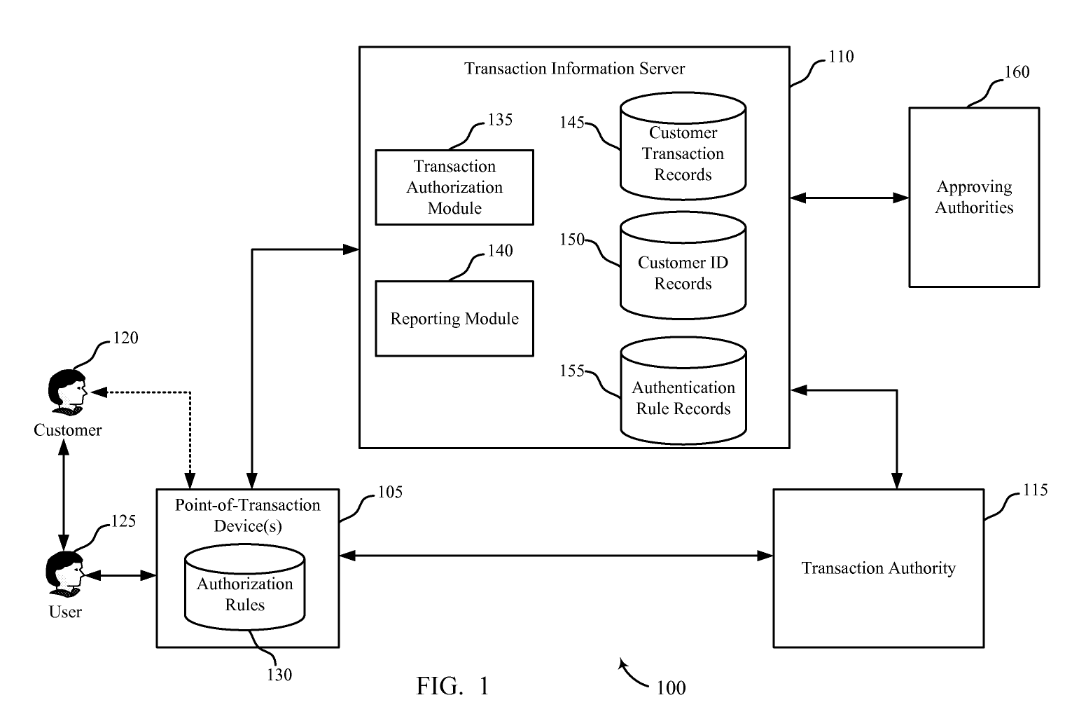

FIG. 1 illustrates an example system 100 configured for transaction processing according to embodiments of the present disclosure. The system 100 includes a Point-of-Transaction device(s) 105, a transaction information server 110, a transaction authority 115, and approving authorities 160. Each of these components may be in communication, directly or indirectly, via one or more of a wired and/or a wireless communications channel.

In the example of FIG. 1, the point-of-transaction device 105 is located proximate a customer 120 and/or a user 125. For example, the point-of-transaction device 105 may be located in a business establishment operated by the user 125. Generally, the point-of-transaction device 105 may be configured to permit the user 125 to input, capture, transmit, and/or receive parameters related to the transaction. The point-of-transaction device 105 may be configured to permit the user 125 to input or capture a request for a transaction that includes a transaction amount, a customer identifier code relating to the customer 120, and an identification parameter.

The transaction amount may include information or data indicative of the monetary amount involved in the transaction (e.g., the dollar amount) or some other information indicative of the item/service being exchanged during the transaction. As noted, a transaction may not necessarily involve the exchange of monetary funds. According to one example, the transaction may be for the distribution of government subsidies to individuals. In that example, the transaction amount may refer to the quantity of subsidies issued to the customer 120.

The customer identifier code may include information provided by the customer to initially identify the customer. For example, the customer identifier code may be a name, an address, a telephone number, a uniquely assigned customer ID number, etc., that is received from the customer 120 during the transaction.

The identification parameter may include information captured from the customer 120 during the transaction. For example, the point-of-transaction device 105 may be configured to capture an image, a voice print, a fingerprint, or any other form of biometric data from the customer 120 contemporaneous to the transaction. Also, or alternatively, the point-of-transaction device 105 may be configured to capture an image of an identification card provided by the customer 120 as proof of identity, e.g., an image of the customer 120's drivers license, government issued identification card, etc. As indicated by the dashed line, the customer 120 may input some of the information into the point-of-transaction device 105 during the transaction process.

The identification parameter may be collected from the customer 120 as a part of the transaction, i.e., contemporaneous to the transaction. As indicated by the dashed line, certain embodiments permit the customer 120 to input some of the parameters associated with the transaction into the point-of-transaction device 105.

The point-of-transaction device 105 is communicatively coupled to the transaction information server 110 via one or more of a wired and/or a wireless communication channel. For a given transaction, the point-of-transaction device 105 may transmit the request for the transaction to the transaction information server 110 via at least one of the communications channels.

The transaction information server 110 may include a transaction authorization module 135, a reporting module 140, a customer transaction records 145, a customer ID records 150, and a authentication rule records 155. Each of these components may be communicatively coupled via, for example, a common bus or other communications channel. The transaction information server 110 may be communicatively coupled with a number of point-of-transaction devices 105 (only one being shown in FIG. 1 for clarity), the transaction authority 115, and the approving authorities 160. Broadly, the transaction information server 110 may be configured to receive the request for a transaction from the point-of-transaction device 105, authenticate or otherwise confirm the identity of the customer based on the identification parameter and the customer identifier code, establish a transaction identifier code for the transaction, and return the transaction identifier code to the point-of-transaction device 105. The transaction information server 110 may be implemented by a single server device or by a number of related components interconnected over a network.

The customer transaction records 145 may be electronic records stored in memory and include information related to, for example, current or previous transactions for each customer 120. As one example, the customer transaction records may include information relating to all the transactions that a particular customer 120 has been a party to. Accordingly, the transaction information server 110 can associate the identity of the customer 120 with the other transaction parameters as well as determine that customer's transaction history. In certain examples, the customer transaction records 145 may be organized by customer identifier code.

The customer ID records 150 may be electronic records stored in memory and include information related to a plurality of customers 120. For example, the customer identifier code contained in the request for the transaction can be the name of the customer 120. In this example, the customer ID records 150 may include an address, telephone number, date of birth, etc, for the customer 120 identified by the customer identifier code. Additionally or alternatively, the customer ID records 150 may include biometric information related to the customer 120, e.g., an image of the customer 120, a fingerprint of the customer 120, etc. According to further embodiments, when the customer transaction records 145 and/or the customer ID records 150 do not have a record stored for a customer identifier code received in a transaction request, the transaction information server 110 may also be configured to create and store a record for that customer 120 as a part of an initial registration process. Alternatively, when no records exist for the customer 120, the transaction information server 110 may enter into a customer registration process before establishing the transaction identifier code.

The authentication rule records 155 may be electronic records stored in memory and include information related to predetermined rules for given transactions. Generally, it can be appreciated that restrictions exist relating to certain transaction types, amount, frequency, etc. For example, certain rules may prohibit or control the transfer of currency, or a predetermined amount of currency, in to or out of a particular geographic region. Other rules may prohibit or control the ability of certain customers 120 to participate in some transactions (e.g., prohibit a convicted felon from purchasing a gun). Even further, some rules may limit the frequency of transactions for a particular customer 120 within a given time period (e.g., the number of times a customer 120 may be distributed certain items or provisions). The authentication rule records 155 include information relating to such transaction rules which can be utilized by each transaction as an additional form of transaction security and fraud prevention.

Each of the records 145, 150, and/or 155 may be stored in memory, in one or more database(s), etc., either locally or remotely from the transaction information system 100.

The transaction authorization module 135 includes logic, hardware, or the like to receive a request for a transaction, the request including the transaction amount, the customer identifier code, and the identification parameter. The transaction authorization module 135 may access the customer ID records 150 to retrieve information associated with the customer identifier code. According to some embodiments, the transaction authorization module 135 may compare certain of the retrieved information with the identification parameter to confirm the identity of the customer 120. For instance, if the identification parameter is an image of the customer 120 that is captured contemporaneous to the transaction, the transaction authorization module 135 may retrieve a stored image from the customer ID records 150 that is associated with the customer identifier code and use a facial recognition algorithm to confirm the identity the customer 120. Other aspects may provide for the confirmation based on fingerprint comparison. If the algorithm cannot confirm the identity of the customer 120, the transaction authorization module may reject that transaction or flag the transaction for manual review for identity confirmation.

Other embodiments may provide for the transaction authorization module 135 to access records from the customer transaction records 145 and/or the authentication rule records 155 to determine whether the customer 120 is authorized to engage in the transaction. As one example, if the customer transaction records 145 indicate that the customer 120 has engaged in four similar transactions types within a predetermined time period and the authentication rules records 155 indicate that a given customer is only permitted to engage in that type of transaction four times within the predetermined time period, the transaction authorization module 135 may determine that the customer 120, even though their identity has been confirmed, is rejected for that transaction.

Other embodiments may provide for the transaction information server 110 to communicate with the approving authorities 160 to confirm the identity of the customer 120. That is, the transaction authorization module 135 may communicate information for the customer 120 associated with the customer identifier code along with the identification parameter to the approving authority 160. According to some embodiments, the approving authority 160 accesses the information on the transaction information server 110 via a series of web pages or other network communications, for example, to confirm the identity of the customer 120. The approving authority 160 may review the information and, in some instances, additional information maintained by the approving authority 160, to confirm the identity of the customer 120. According to even further embodiments, multiple approving authorities 160 may be utilized to confirm the identity of the customer 120. Each of the multiple approving authorities 160 may confirm certain aspects of the identity of the customer 120 in a hierarchical manner where a first approving authority 160 confirms a first aspect before a second approving authority 160 confirms a second aspect. Other embodiments may provide for the second approving authority 160 to re-confirm the identity component confirmed by the first approving authority 160 as an anti-fraud measure. A confirmation signal may be provided to the transaction information server 110 by the approving authorities 160 after the customer 120's identification is confirmed.

Once the identity of the customer 120 has been confirmed and, when applicable, the customer 120 has been determined eligible for the transaction, a transaction identifier code can be established for the transaction. According to certain embodiments, the transaction information server 110 may establish the transaction identifier code and communicate the transaction identifier code to the point-of-transaction device 105. According to other embodiments, the transaction information server 110 can communicate with the transaction authority 115 to establish the transaction identifier code. In still other examples, the transaction information server 110 and the transaction authority 115 may separately determine the same transaction identifier code for a transaction based on a shared convention or protocol.

By way of example only, the transaction authority 115 may be a credit card issuing company. In this example, the transaction information server 110 can communicate information to the transaction authority 115 indicating that the identity of the customer 120 has been confirmed and, when applicable, that the customer 120 is not otherwise prohibited from engaging in the transaction. In return, the transaction authority 115 may issue the transaction identifier code to the transaction information server 110.

The transaction information server 110 may communicate the transaction identifier code to the point-of-transaction device 105. The point-of-transaction device 105 may then transmit the received transaction identifier code to the transaction authority 115, which may recognize the transaction identifier code as a valid transaction identifier code provided by the transaction information server 110. Based on this recognition, the transaction authority may approve the transaction and, in some cases, generate settlement instructions for the trans action.

The reporting module 140 may be configured to generate one or more reports relating to the records stored by the transaction information server 110. Exemplary reports may be for a particular customer 120, for a particular user 125, for a particular transaction type, may be based on one or more predetermined time periods, etc. In other embodiments the reporting module 140 may be configured to dynamically generate custom reports or store one or more predefined reports that can be retrieved for use. The transaction information server 110 may communicate the reports to, for example, the approving authority 160, the user 125, the customer 120, and/or the transaction authority 115. Other aspects provide for the transaction information server to make the reports available via a series of one or more web pages accessible using a web browser.

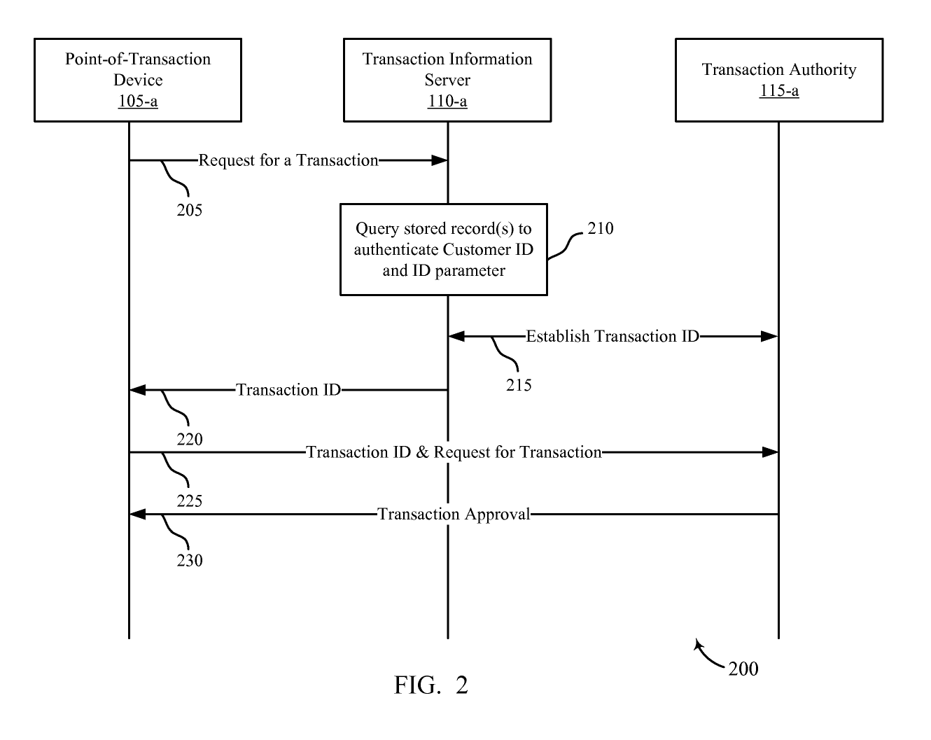

FIG. 2 is a diagram illustrating an exemplary communication flow 200 for transaction processing in accordance with various embodiments. Communication flow 200 may be used, for example, by the point-of-transaction device 105, the transaction information server 110, and the transaction authority 115 of FIG. 1 for transaction processing.

At 205, the point-of-transaction device 105-a communicates a request for a transaction to the transaction information server 110-a via one or more communications channels. The transaction request may include a transaction amount, a customer identifier code, and an identification parameter. At 210, the transaction information server 110-a authenticates the identity of the customer based on the customer identifier code and the identification parameter. For example, the transaction authorization module 135 may query any or all of the customer transaction records 145, the customer ID records 150, and/or the authentication rule records 155 to confirm the identity of the customer and, when necessary, confirm that the customer is authorized to engage in the transaction.

Once the identity of the customer is confirmed, at 215 the transaction information server 110-a establishes the transaction identifier code. As discussed, the transaction information server 110-a may establish the transaction identifier code. In the exemplary communication flow 200, however, the transaction information server 110-a communicates with the transaction authority 115-a to establish the transaction identifier code. At 220, the transaction information server 110-a communicates the transaction identifier code to the point-of-transaction device 105-a. It can be appreciated that, for certain transaction types, the point-of-transaction device 105 may approve and complete the transaction based on receipt of the transaction identifier code. For example, for a cash-based transaction, receipt of the transaction identifier code indicates that the identity of the customer has been confirmed, that the customer is authorized to engage in the transaction, and that a record associating the customer with the transaction has been stored by the transaction information server 110-a. Accordingly, the point-of-transaction device 105-a completes the transaction between the user and the customer.

In certain examples, one or more related devices associated with a merchant or service provider at the point of transaction may implement the functionality of the point-of-transaction device 110-a. For example, in certain examples a merchant may have a terminal for communicating with the transaction authority 115-a over a first network connection and a mobile device (e.g., a smartphone, tablet, special-purpose device, etc.) programmed to communicate with the transaction information server 110-a over a second network connection. In this case, the merchant may provide 205 the transaction request to the transaction information server 110-a and receive the transaction ID 220 from the transaction information server 110-a using the mobile device, and then provide 225 the transaction ID to transaction authority 115-a and receive 230 the transaction approval using the merchant terminal. In this way, the additional protections, security, and record-keeping of the transaction information server 110-a may be integrated into the transactions conducted by the merchant without need of updating the terminal for communicating with the transaction authority 115-a.

According to certain transaction types (e.g., credit/debit card transactions, subsidy distribution, etc.), the point-of-transaction device 105-a may communicate with the transaction authority 115-a before completing the transaction. That is, while the transaction information server 110-a may confirm the identity of the customer, determine whether the customer is authorized to engage in the transaction, and/or associate the customer identity with the transaction, the transaction information server 110-a may not, in some circumstances, provide the final authorization for the transaction. In the example discussed above, the transaction authority 115-a may be a credit card issuing company where the transaction authority 115-a authorizes the charge to the customer's credit card. This example is illustrated at 225 where the point-of-transaction device 105-a communicates at least a portion of the transaction request and the transaction identifier code to the transaction authority 115-a. At 230, the transaction authority 115-a communicates the transaction approval confirmation signal to the point-of-transaction device 105-a.

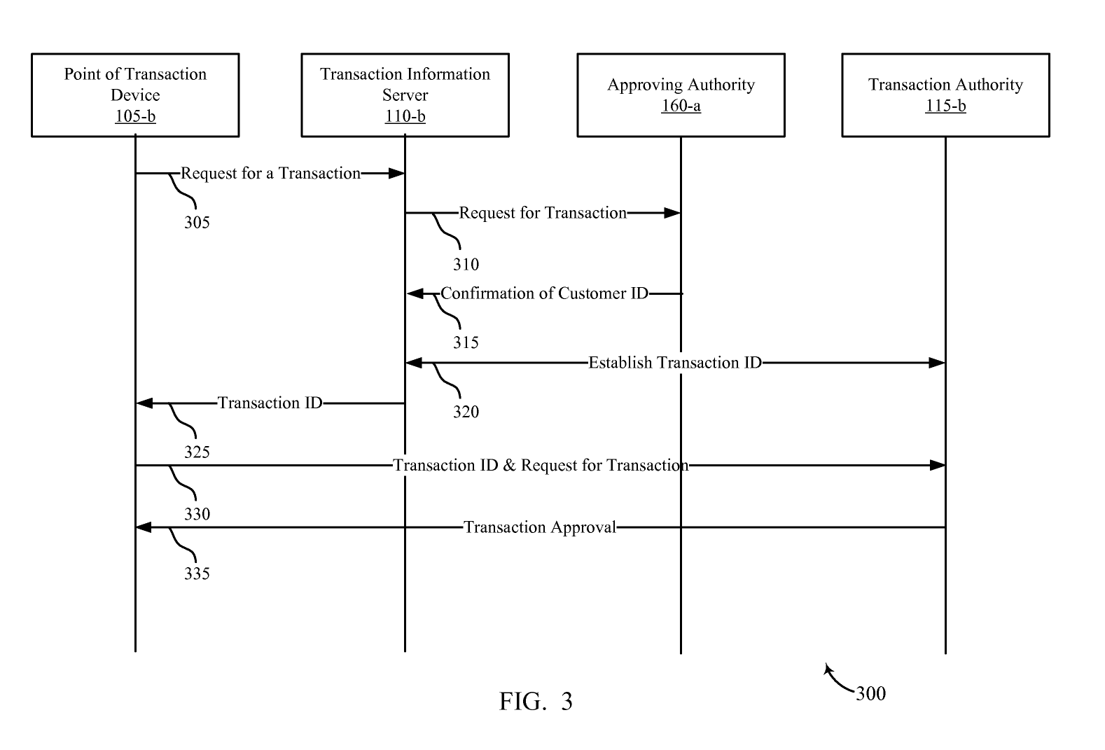

FIG. 3 is a diagram illustrating an exemplary communication flow 300 for transaction processing in accordance with various embodiments. Communication flow 300 may be used, for example, by the point-of-transaction device 105, the transaction information server 110, the transaction authority 115, and the approving authority 160 of FIG. 1 for transaction processing. Generally, the communication flow 300 illustrates the circumstance where the separate approving authority 160-a confirms, in whole or in part, the identity, qualifications, or eligibility of the customer with respect to the transaction.

At 305, the point-of-transaction device 105-b communicates the request for a transaction to the transaction information server 110-b. At 310, the transaction information server 110-b communicates at least a portion of the transaction request to the approving authority 160-a. In some examples, the transaction information server 110-b queries the customer ID records 150 using the customer identifier code to retrieve additional information associated with the customer. The transaction server 110-b may forward at least a portion of the retrieved customer information along with the identification parameter from the transaction request to the approving authority 160-a. The approving authority 160-a may utilize the communicated information to confirm the identity of the customer. In some examples, the approving authority utilizes multiple levels of approval authority wherein each level is approved before the next level approves the confirmation of the identity. At 315, the approving authority 160-a communicates a signal to the transaction information server 110-b indicating confirmation of the customer identification.

At 320, the transaction information server 110-b communicates with the transaction authority 115-b to establish the transaction identifier code. The transaction information server 110-b communicates the transaction identifier code to the point-of-transaction device 105-b at 325. At 330, the point-of-transaction device 105-b communicates at least a portion of the transaction request along with the transaction identifier code to the transaction authority 115-b for final authorization. At 335, the transaction authority 115-b communicates a confirmation signal to the point-of-transaction device 105-b indicating that the transaction is approved.

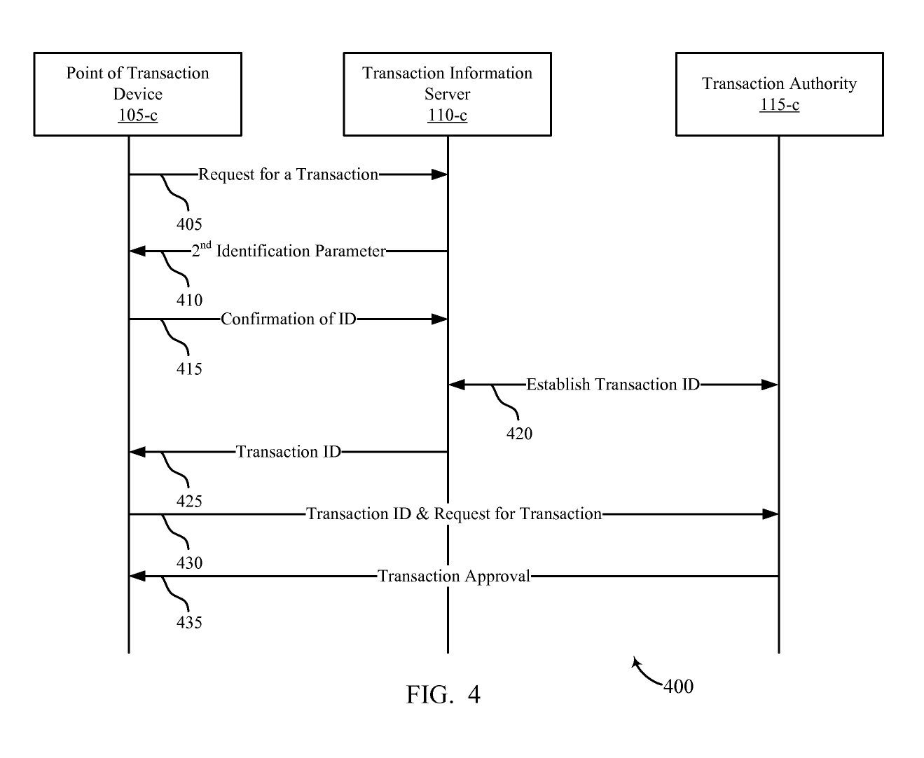

FIG. 4 is a diagram illustrating an exemplary communication flow 400 for transaction processing in accordance with various embodiments. Communication flow 400 may be used, for example, by the point-of-transaction device 105, the transaction information server 110, and the transaction authority 115 of FIG. 1 for transaction processing. Generally, the communication flow 400 illustrates the circumstance where a second identification parameter is communicated to the point-of-transaction device 105-c for further identity confirmation by a merchant or service provider associated with the point of transaction device 105-b.

At 405, the point-of-transaction device 105-c communicates the request for a transaction to the transaction information server 110-c. At 410, the transaction information server 110-c communicates a second identification parameter to the point-of-transaction device 105-c. According to certain embodiments, the transaction information server 110-c may query the customer ID records 150 using the customer identifier code to retrieve the second identification parameter associated with the customer. In some examples, the second identification parameter may be an image of the customer associated with the customer identifier code. The image associated with the customer identifier code may be returned to the point-of-transaction device 105-c at 410 where the user 125 can compare the image to the customer 120 to confirm the identity of the customer. At 415, the point-of-transaction device 105-c communicates a confirmation signal to the transaction information server 110-c confirming the identity of the customer.

At 420, the transaction information server 110-c communicates with the transaction authority 115-c to establish the transaction identifier code. The transaction information server 110-c communicates the transaction identifier code to the point-of-transaction device 105-c at 425. At 430, the point-of-transaction device 105-c communicates at least a portion of the transaction request along with the transaction identifier code to the transaction authority 115-c for final authorization. At 435, the transaction authority 115-c communicates a confirmation signal to the point-of-transaction device 105-c indicating that the transaction is approved.

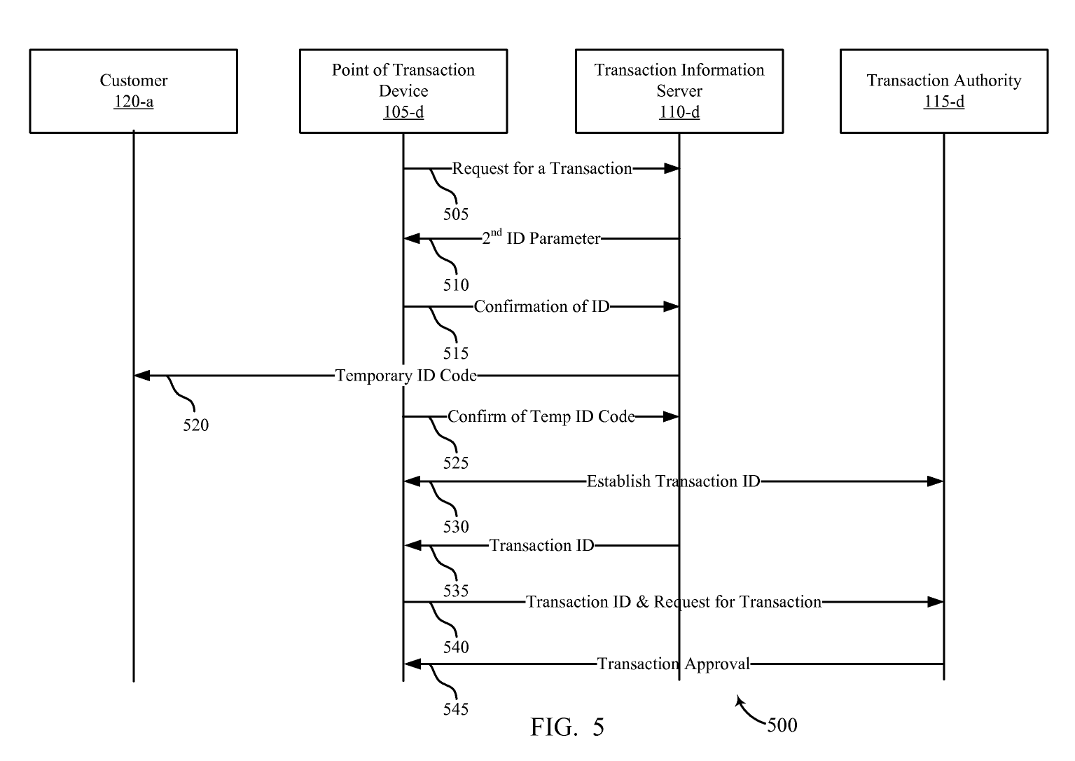

FIG. 5 is a diagram illustrating an exemplary communication flow 500 for transaction processing in accordance with various embodiments. Communication flow 500 may be used, for example, by the point-of-transaction device 105, the transaction information server 110, and the transaction authority 115 of FIG. 1 for transaction processing. Generally, the communication flow 500 illustrates the circumstance where a second identification parameter is returned to the point-of-transaction device 105 and also where a temporary ID code is communicated to the customer 120-a as additional forms of identity confirmation.

At 505, the point-of-transaction device 105-d communicates the request for a transaction to the transaction information server 110-d. At 510, the transaction information server 110-d communicates a second identification parameter to the point-of-transaction device 105-d. The transaction information server 110-d may retrieve the second identification parameter by querying the customer ID records 150 using the customer identifier code included in the transaction request. The second identification parameter may be an image of the customer associated with the customer identifier code. The image may be returned to the point-of-transaction device 105-d where the user can confirm the identity of the customer. At 515, the point-of-transaction device 105-d communicates a confirmation signal to the transaction information server 110-d confirming the identity of the customer.

At 520, the transaction information server 110-d communicates a temporary ID code to the customer 120-a. In some embodiments, the transaction information server 110-d may also retrieve from the records additional contact information for the customer associated with the customer identifier code (e.g., a telephone number and/or an e-mail address). Utilizing the contact information, the transaction information server 110-d may establish a temporary ID code, e.g., a one-time personal identification number (OTP), for the transaction and communicate the code to the customer as a text message or e-mail, for example. The customer 120-a may provide the temporary ID code to the user 125 to be input to the point-of-transaction device 105-d or the customer 120-a may input the temporary code into the point-of-transaction device 104-d directly. At 525, the point-of-transaction device 105-d communicates a confirmation signal to the transaction information server 110-d confirming the temporary ID code was received by the customer during the transaction. The confirmation signal may be the temporary identification code where the transaction information server 110-c confirms that the correct temporary identification code is returned. As can be appreciated, use of the temporary ID code provides yet another form of identification verification according to various embodiments. Furthermore, it should be understood that the use of a temporary ID in this manner may be integrated into one or more of the communication flows described with reference to the other Figures of the present specification, or other embodiments of the principles described herein, to add an additional layer of security to the transaction.

At 530, the transaction information server 110-d communicates with the transaction authority 115-d to establish the transaction identifier code. The transaction information server 110-d communicates the transaction identifier code to the point-of-transaction device 105-d at 535. At 540, the point-of-transaction device 105-d communicates at least a portion of the transaction request along with the transaction identifier code to the transaction authority 115-d for final authorization. At 545, the transaction authority 115-d communicates a confirmation signal to the point-of-transaction device 105-d indicating that the transaction is approved.

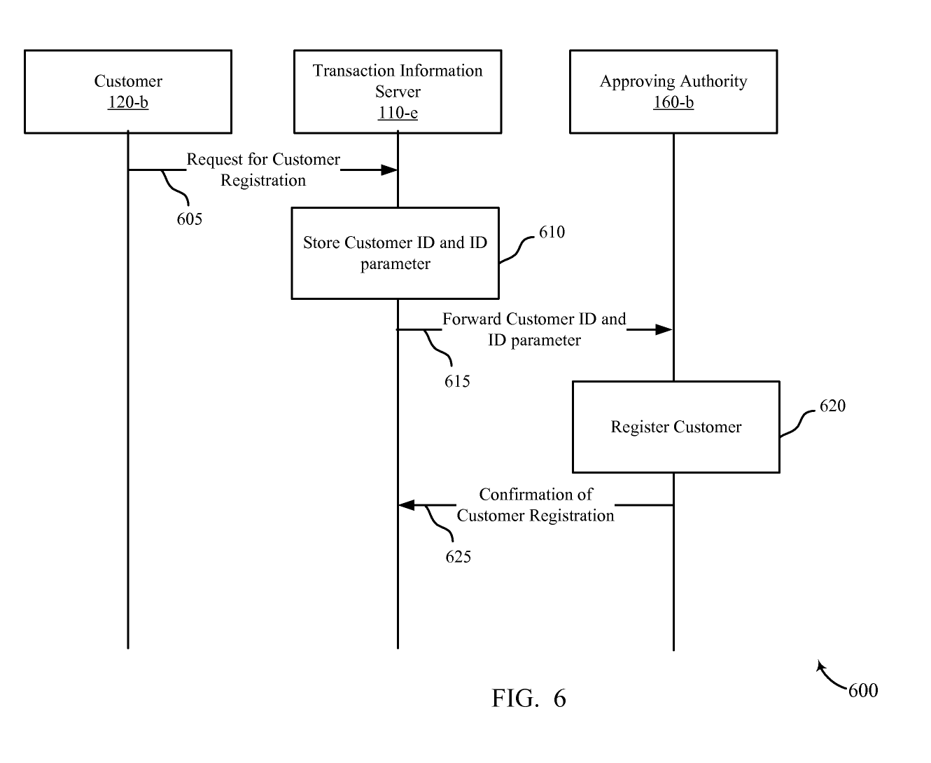

FIG. 6 is a diagram illustrating an exemplary communication flow 600 for transaction processing in accordance with various embodiments. Communication flow 600 may be used, for example, by the point-of-transaction device 105, the transaction information server 110, and the transaction authority 115 of FIG. 1 for transaction processing. Generally, the communication flow 600 illustrates the circumstance where a customer 120-b pre-registers with the transaction information server 110-e and/or the approving authority 160-b.

At 605, the customer 120-b submits a request for customer registration to the transaction information server 110-e. The registration request may include information associated with the customer 120-b, e.g., the customer's name, address, home/mobile telephone numbers, e-mail addresses, and the like. According to some embodiments, the request may include biometric information associated with the customer 120-b, e.g., an image of the customer, a fingerprint scan of the customer, and the like. According to even further embodiments, the registration request may include an image of an identification card of the customer, e.g., the customer's drivers license and/or a government issued identification card.

At 610, the transaction information server 110-e stores the customer identification data as well as the identification parameter submitted by the customer 120-b. In some examples, the transaction information server 110-e creates one or more records for the customer 120-d in memory. At 615, the transaction information server 110-e may forward at least a portion of the registration request from the customer 120-b to the approving authority 160-b. In certain examples, the transaction information server 110-e may forward all of the customer identification data as well as the identification parameters to the approving authority 160-b. At 620, the approving authority 160-b registers the customer 120-b based on the received registration request. According to certain embodiments, the approving authority 160-b authenticates the information submitted in the registration request based on comparison with one or more internal or external information sources containing identification data associated with the customer 120-b. Exemplary information sources include, but are not limited to, customer databases maintained by the transaction authority 115, information stores maintained by one or more government agencies, and the like.

At 625, the approving authority 160-b communicates a confirmation signal to the transaction information server 110-e indicating that the customer has been registered. As can be appreciated, if the approving authority 160-b cannot confirm the identity of the customer based on the information in the registration request, the approving authority 160-b may withhold the confirmation signal 625. According to some embodiments, in the case where the registration cannot be confirmed, the transaction information server 110-e and/or the approving authority 160-b may contact the customer 120-b and request that the customer visit a local agent (e.g., the user 125) to submit additional information and/or clarify certain information.

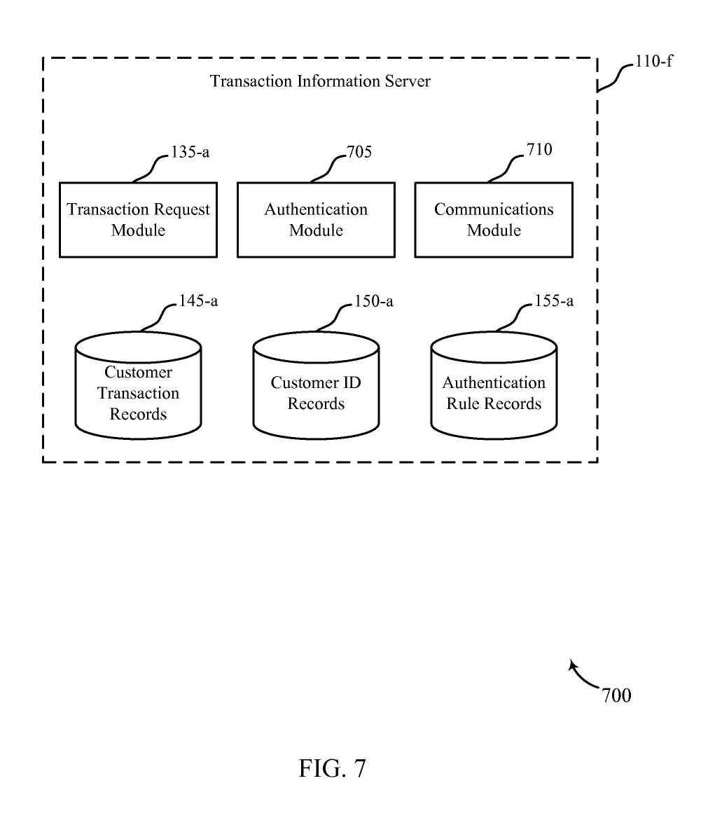

FIG. 7 is a block diagram 700 of an example transaction information server 110-f for transaction processing in accordance with various embodiments of the present disclosure. The transaction information server 110-f may implement aspects and/or components of the transaction information servers 110 of FIGS. 1-5 as well as implementing aspects of communication flows 200, 300, 400, and/or 500. The transaction information server 110-f may be implemented in whole, or in part, as a processor.

Transaction information server 110-f includes a transaction request module 135-a, an authentication module 705, a communications module 710, a customer transactions records 145-a, a customer ID records 150-a, and an authentication rule records 155-a, which each may be in communication, directly or indirectly, with each other. The communications module 710 may be configured to communicate via one or more communications channel(s). The one or more communications channels may be wired, wireless, or a combination of wired and wireless communications channels. The communications module 710 may be configured to permit the transaction information server 110-e to operatively communicate with the point-of-transaction device 105, the transaction authorities 115, and/or the approving authority 160. The communications module 710 may communicate with the point-of-transaction device 105, for example, via a first communications channel (e.g., wirelessly via a cellular network) and communicate with the transaction authority via a second communications channel (e.g., wired via the Internet). The transaction request module 135-a may be configured to receive the request for a transaction from the point-of-transaction device 105 (via the communications module 710). The transaction request may include the transaction amount, the customer identifier code, and the identification parameter that is captured contemporaneously with the transaction.

The transaction request module 135-a may communicate with the customer ID records 150-a to retrieve additional information associated with the customer identifier code. The transaction request module 135-a and/or the authentication module 705 may be configured to utilize the customer identifier code, the identification parameter, and the additional information retrieved from the customer ID records 150-a to authenticate (or confirm) the identity of the customer. Upon authentication or confirmation of the identity of the customer (e.g., using the identification parameter) or the customer's eligibility with respect to the transaction, the transaction information server 110-e may communicate, via communications module 710, with the transaction authority to establish a transaction identifier code for the transaction based on the authentication of the identification parameter. According to certain embodiments, the transaction request module 135-a and/or the authentication module 705 may be configured to query the customer transaction records 145-a and/or the authentication rules records 155-a to determine whether the identified customer is authorized to engage in the transaction.

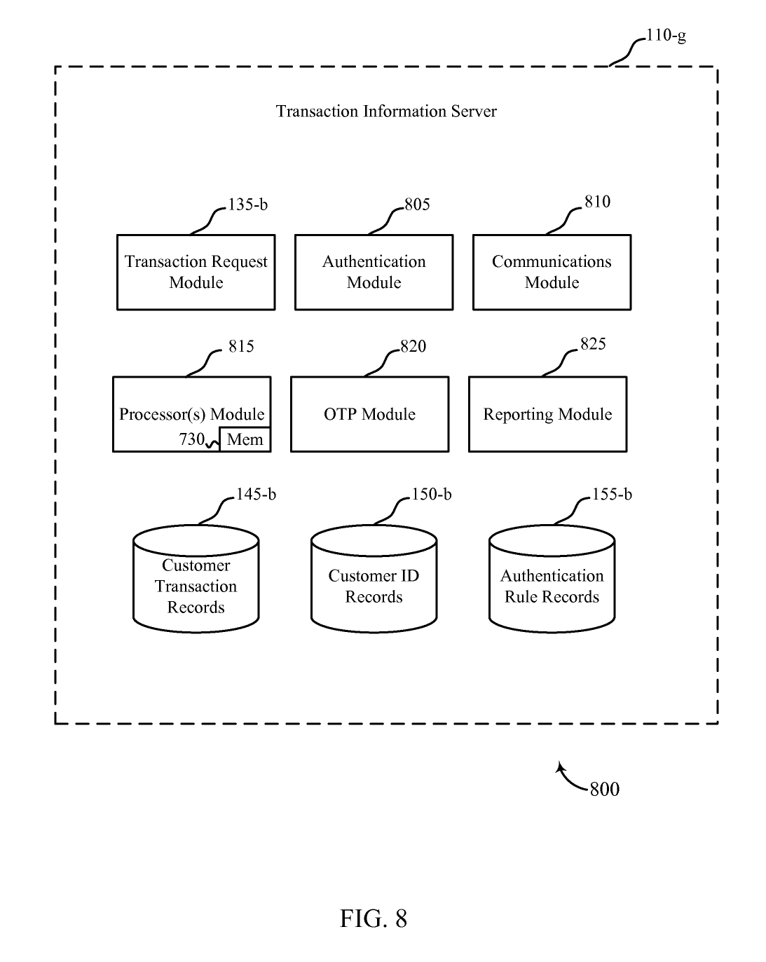

FIG. 8 a block diagram 800 of another example transaction information server 110-g for transaction processing in accordance with various embodiments of the present disclosure. The transaction information server 110-g may implement aspects and/or components of the transaction information servers 110 of FIGS. 1-6 as well as implementing aspects of communication flows 200, 300, 400, and/or 500. Aspects of the transaction information server 110-g may be a processor.

Transaction information server 110-g includes a transaction request module 135-b, an authentication module 805, a communications module 810, a processor module 815, a one-time PIN (OTP) module 820, a reporting module 825, a customer transactions records 145-b, a customer ID records 150-b, and an authentication rule records 155-b, which each may be in communication, directly or indirectly, with each other. The communications module 810 may be configured to communicate via one or more communications to transmit and receive various information for transaction processing. The transaction request module 135-b and/or the authentication module 805 may be configured to receive the transaction request including the parameters associated with the transaction and also the identification parameter. The modules 135-b and/or 805 may be configured to query one or more of the customer transaction records 145-b, the customer ID records 150-b, and/or the authentication rule records 155-b to (1) retrieve additional information for the customer associated with the customer identifier code, (2) verify the identity of the customer based on the additional information and the identification parameter, (3) when necessary, determine whether the customer is authorized to engage in the transaction, and (4) establish a transaction identifier code for the transaction that is communicated to the point-of-transaction device 105.

The processor module 815 includes a memory 830. The memory 830 may include random access memory (RAM) and read-only memory (ROM). The memory 830 may store computer-readable, computer-executable software code containing instructions that are configured to, when executed, cause the processor module 815 to perform various functions described herein (e.g., transaction processing). Alternatively, the software may not be directly executable by the processor module 815 but may be configured to cause a computer (e.g., when compiled and executed) to perform functions described herein. The processor module 815 may include an intelligent hardware device, e.g., a central processing unit (CPU), a microcontroller, an application specific integrated circuit (ASIC), etc. The OTP module 820 may be configured to establish a temporary identification code to be communicated to the customer via the communications module 810, for example, and then determine whether a confirmation signal received from the point-of-transaction device 105 accurately reflects the temporary identification code. That is, as previously discussed, another factor of identity confirmation may include sending a temporary identification code to the customer using contact information retrieved from the customer ID records 150-b and associated with the customer identifier code. The customer, who is located with the user and/or the point-of-transaction device 105 may then provide the temporary identification code to be communicated back to the transaction information server 110-g. The OTP module 820 is configured to receive the confirmation signal from the point-of-transaction device 105 and determine whether the correct temporary identification code has been returned. If so, the OTP module 820 may communicate such confirmation to the transaction request module 135-b and/or the authentication module 805. The modules 135-b and/or 805, based on the received confirmation, may then determine that the identity of the customer has been verified.

The reporting module 825 may be configured to query one or more of the records 145-b, 150-b, and/or 155-b to retrieve information related to particular transactions and/or customers. The reporting module 825 may establish one or more reports utilizing such information and provide the reports for viewing, downloading, printing, etc. According to certain embodiments, a remote user (e.g., the transaction authority 115 and/or the approving authority 160) may access the reports module 825 of the transaction information server 110-g via a series of one or more web pages presented via a web browser in order to customize, generate, and/or otherwise view the reports. Exemplary reports that the reports module 825 can provide include, but are not limited to, a report of every transaction a given customer has engaged in, a report of every transaction for a given transaction type, a report of every transactions associated with a given point-of-transaction device 105, a report of every transaction that has been denied as a result of violation of one or more of the authentication rule records 155-b, etc. Further, the reports can be based on one or more predetermined time periods.

The components of the transaction information servers 110 may be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the transaction information servers 110.

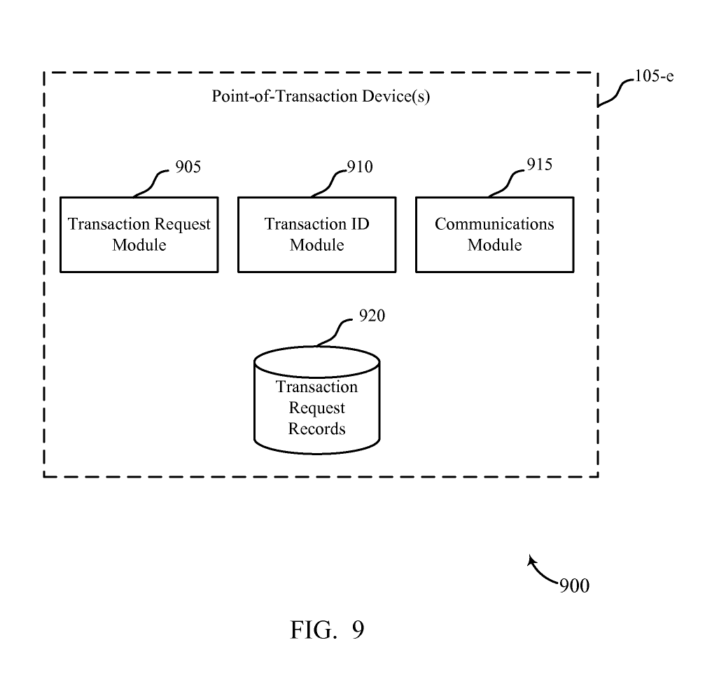

FIG. 9 a block diagram 900 of an example point-of-transaction device 105-e for transaction processing in accordance with various embodiments of the present disclosure. The point-of-transaction device 105-e may implement aspects and/or components of the point-of-transaction devices 105 of FIGS. 1-5 as well as implementing aspects of communication flows 200, 300, 400, and/or 500. Aspects of the point-of-transaction device 110-e may be implemented by one or more processors.

Point-of-transaction device 105-e includes a transaction request module 905, a transaction ID module 910, a communications module 915, and a transaction request records 920. The communications module 915 may be configured to operatively communicate via one or more communications channels. The communications channels may be wired, wireless, or combinations of wired and wireless. Exemplary communications channels include a cellular communications network, a wireless local area network (e.g., WiFi) communications network, a series of interconnected computers, etc. According to certain embodiments, the communications module 915 is configured to operatively communicate with the transaction information server 110 and/or a transaction authority 115.

The transaction request module 905 may be configured to receive the certain parameters associated with a transaction. For instance, the transaction request module may be configured to receive a transaction amount, a customer identifier code, and/or an identification parameter captured from a customer contemporaneously with the transaction. According to some embodiments, the user 125 and/or the customer 125 may enter the transaction parameters into the point-of-transaction device 105-e. Other aspects may provide for the point-of-transaction device 105-e to be configured to permit scanning an electro-magnetic stripe of a card to enter some of the transaction parameters. The transaction request module 905 may be configured to communicate the transaction request (via the communications module 915) to the transaction information server 110. For instance, the transaction request may form one or more data packets forming the transaction request in a manner that is retrievable by the transaction information server 110.

The transaction ID module 910 may be configured to receive the transaction identifier code. As previously discussed, the transaction information server 110 may retrieve information from the customer ID records 150 that is associated with the customer identifier code, authenticate the identity of the customer based on the customer information and the identification parameter, and establish a transaction identifier code that is communicated to the point-of-transaction device 105-e. The transaction ID module 910 may be configured to receive the transaction identifier code, transmit the transaction identifier code to the transaction authority, and receive an approval for the transaction from the transaction authority based on the transaction identifier code and the request.

The transaction request records 920 may include electronic information stored by the point-of-transaction device 105-e that is associated with different transaction types, with different transaction parameters, etc. In some embodiments, the transaction request module 905 receives the transaction parameters and queries the transaction request records 920 to determine aspects of the information that is to be included in the transaction request. For example, the transaction request records 920 may include information indicating what transaction parameters to include in the transaction request based on the transaction type, the transaction amount, etc.

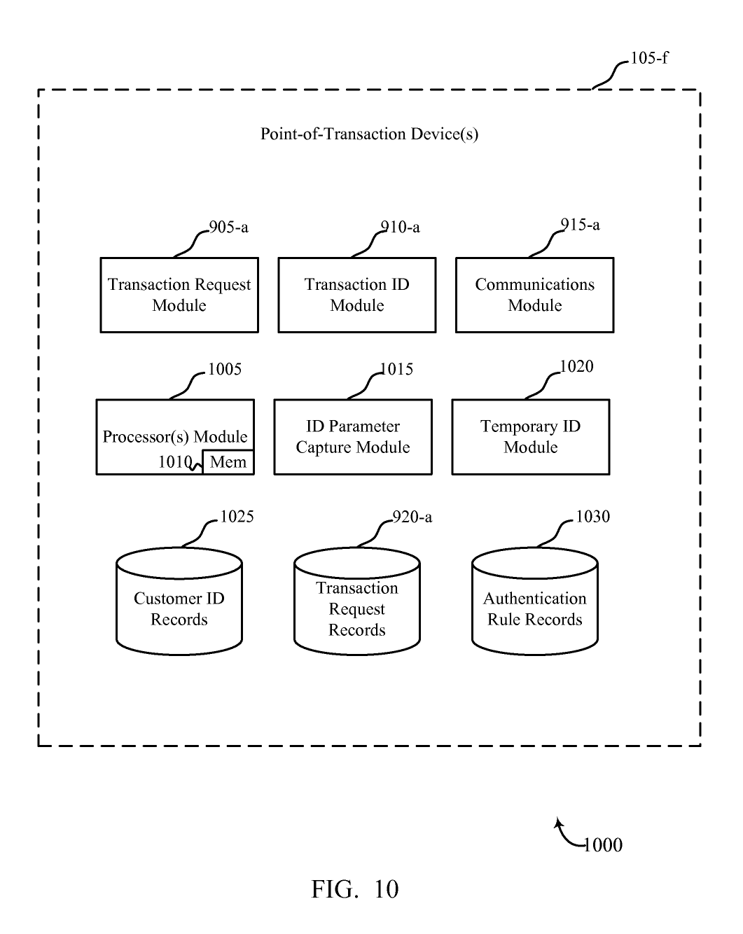

FIG. 10 is a block diagram 1000 of another example point-of-transaction device 105-f for transaction processing in accordance with various embodiments of the present disclosure. The point-of-transaction device 105-f may implement aspects and/or components of the point-of-transaction devices 105 of FIG. 1-5 or 8 as well as implementing aspects of communication flows 200, 300, 400, and/or 500. Aspects of the point-of-transaction device 110-f may be a processor.

The point-of-transaction device 105-f includes a transaction request module 905-a, a transaction ID module 910-a, a communications module 915-a, a processor module 1005 having memory 1010, an ID parameter capture module 1015, a temporary ID module 1020, a customer ID records 1025, a transaction request records 920-a and an authentication rule records 1030. The communications module 915-a may be configured to permit the point-of-transaction device 105-f to operatively communicate via one or more communications channels with the transaction information server 110 and/or the transaction authority 115. The communications channels may be wired, wireless, or combinations of wired and wireless.

The transaction request module 905-a is configured to receive the parameters associated with a transaction, e.g., the transaction amount, the customer identifier code, and/or an identification parameter captured from a customer contemporaneously with the transaction. The transaction request module 905-a may be configured to communicate the transaction request (via the communications module 915-a) to the transaction information server 110. The transaction ID module 910-a may receive the transaction identifier code from the transaction information server 110 and determine whether the transaction is to be approved or denied.

The processor module 1005 includes memory 1010. The memory 1010 may include random access memory (RAM) and read-only memory (ROM). The memory 1010 may store computer-readable, computer-executable software code containing instructions that are configured to, when executed, cause the processor module 1005 to perform various functions described herein (e.g., transaction processing). Alternatively, the software may not be directly executable by the processor module 1005 but may be configured to cause a computer (e.g., when compiled and executed) to perform functions described herein. The processor module 1005 may include an intelligent hardware device, e.g., a central processing unit (CPU), a microcontroller, an application specific integrated circuit (ASIC), etc.

The ID parameter capture module 1015 may be configured to capture the identification parameter contemporaneous to the transaction. According to some embodiments, the ID parameter capture module 1015 may be in operative communication with one or more of an image capture device, a biometric capture device, and the like, either integral to the point-of-transaction device 105-f or as a peripheral component. The ID parameter capture module 1015 may be configured to capture the identification parameter using one or more of said components and store information indicative of the captured data. Other aspects may provide for the ID parameter capture module 1015 to be configured to capture an image of an identification card provided by the customer during the transaction. As can be appreciated, the captured identification parameter may be included in the transaction request and utilized by the transaction information server 110 to confirm the identity of the customer.

The temporary ID module 1020 may be configured to receive the temporary identification code from the customer during the transaction and communicate a confirmation signal to the transaction information server 110 indicating receipt of the code. According to certain embodiments, the temporary ID module 1020 may communicate the temporary identification code back to the transaction information server 110. The transaction request records 1025 may include electronic information being stored that is associated with different transaction types, for example. In some embodiments, the transaction request module 905-a receives the transaction parameters and queries the transaction request records 920-a to determine aspects of the information that is to be included in the transaction request.

According to certain embodiments, certain aspects of the functionality of the transaction information server 110 may be incorporated into the point-of-transaction device 105-f. For instance, the customer ID records 1025 and the authentication rule records 1030 may be included in the point-of-transaction device 105-f. The customer ID records 1025 may be queried by the transaction request module upon receipt of identifying information from the customer to retrieve additional information associated with that customer. For instance, the customer's name may be provided where the customer ID records 1025 is queried to retrieve that customer's address, telephone number, e-mail address, etc. The point-of-transaction device 105-f may use some of all of this retrieved information associated with the customer as the customer identifier code that is communicated to the transaction information server 110 in the transaction request.

According to even further embodiments, the transaction request module 905-a may, to a certain extent, query the authentication rule records to determine if the customer is authorized to engage in the transaction. For example, the authentication rule records 1030 may include stored information relating to the transaction types that can be processed using the point-of-transaction device 105-f. If the user and/or customer attempts to process a transaction type that is forbidden, the transaction request module 905-a may query the authentication rule records 1030, determine that type of transaction type is forbidden, and reject the transaction.

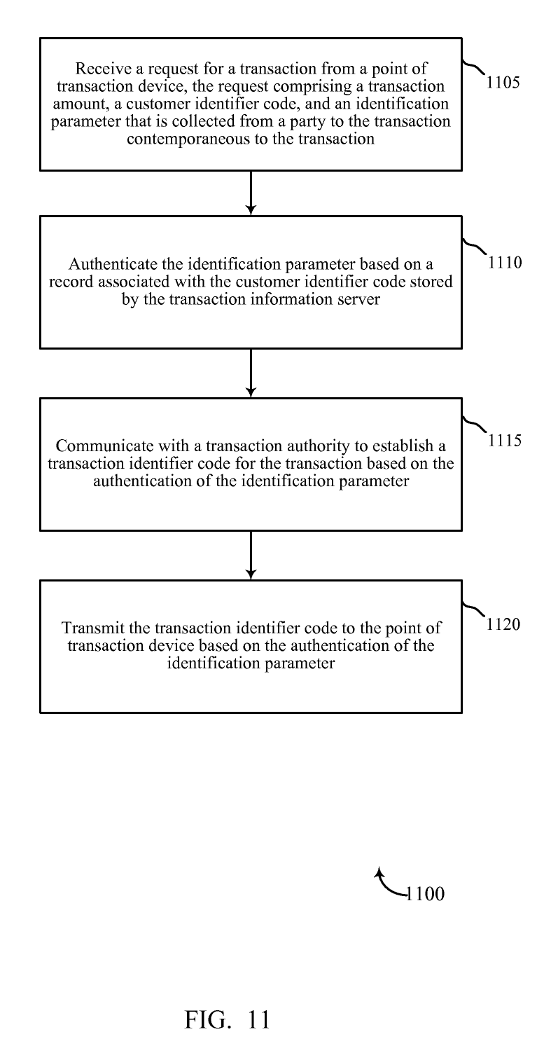

FIG. 11 is a flowchart of a method 1100 for transaction processing in accordance with aspects of the present disclosure. Aspects of the method 1100 may be performed by one or more of the devices 105, 110, 115, and/or 160 of FIGS. 1-9. Similarly, the method 1100 may implement aspects of the communication flows 200, 300, 400, and/or 500. In one implementation, the processor module 715 of the transaction information server 110 may execute one or more sets of codes or computer executable instructions to control the functional elements of the transaction information server 110 to perform the functions described below. In another implementation, the processor module 905 of the point-of-transaction device 105 may execute one or more sets of codes or computer executable instructions to control the functional elements of the point-of-transaction device 105 to perform the functions described below. At block 1105, a transaction information server 110 receives a request for a transaction from a point-of-transaction device 105. The transaction request may include a transaction amount, a customer identifier code, and an identification parameter that is collected from a party to the transaction contemporaneous to the transaction.

At block 1110, the transaction information server 110 authenticates the identification parameter based on a record associated with the customer identifier code. The record may be stored in the customer ID records 150 of the transaction information server 110. According to some embodiments, the record stored in the customer ID records 150 may include additional identification parameters where the transaction information server 110 compares the identification parameters to authenticate the identity of the customer. At block 1115, the transaction information server 110, based on authenticating the identity of the customer, communicates with a transaction authority to establish a transaction identifier code for the transaction. At block 1120, the transaction information server 100 transmits the transaction identifier code to the point-of-transaction device 105 based on the authentication of the identification parameter.

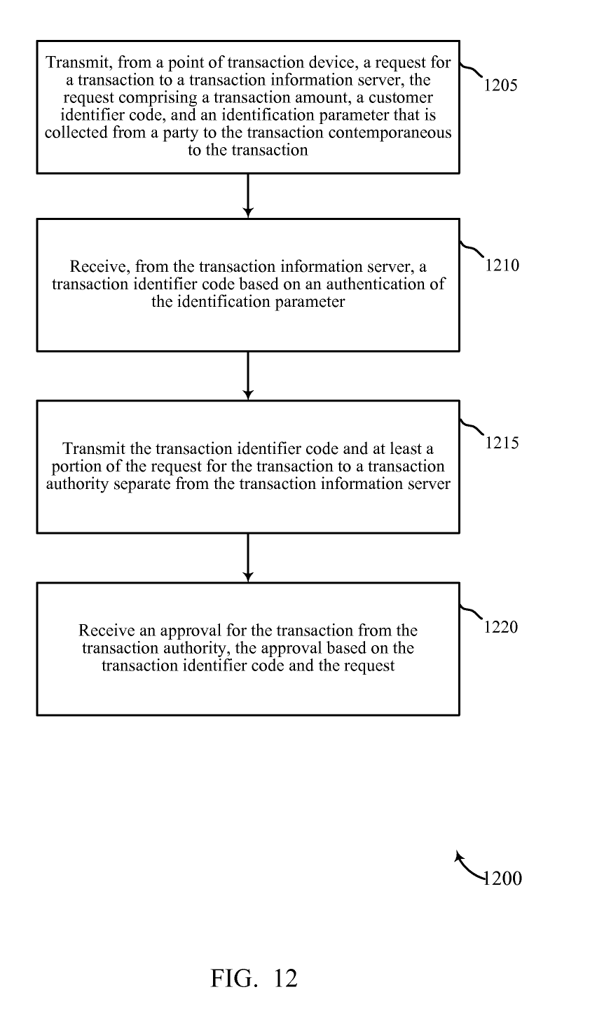

FIG. 12 is a flowchart of a method 1200 for transaction processing in accordance with aspects of the present disclosure. Aspects of the method 1200 may be performed by one or more of the devices 105, 110, 115, and/or 160 of FIGS. 1-9. Similarly, the method 1200 may implement aspects of the communication flows 200, 300, 400, and/or 500. In one implementation, the processor module 905 of the point-of-transaction device 105 may execute one or more sets of codes or computer executable instructions to control the functional elements of the point-of-transaction device 105 to perform the functions described below. At block 1205, the method 1200 begins where a point-of-transaction device 105 transmits a request for a transaction to a transaction information server 110. The transaction request may include a transaction amount, a customer identifier code, and an identification parameter that is collected from a party to the transaction contemporaneous to the transaction.

At block 1210, the point-of-transaction device 105 receives a transaction identifier code from the transaction information server 100. The transaction identifier code indicates that the identity of the customer has been verified and that the customer's identity has been tied to the transaction. At block 1215, the point-of-transaction device 105 transmits the transaction identifier code and at least a portion of the transaction request to the transaction authority 115. The transaction authority 115 is separate from the transaction information server 110, as illustrated above. At block 1220, the point-of-transaction device 105 receives an approval of the transaction from the transaction authority 115. The transaction authority 115 approves the transaction based on the transaction identifier code and the transaction request.

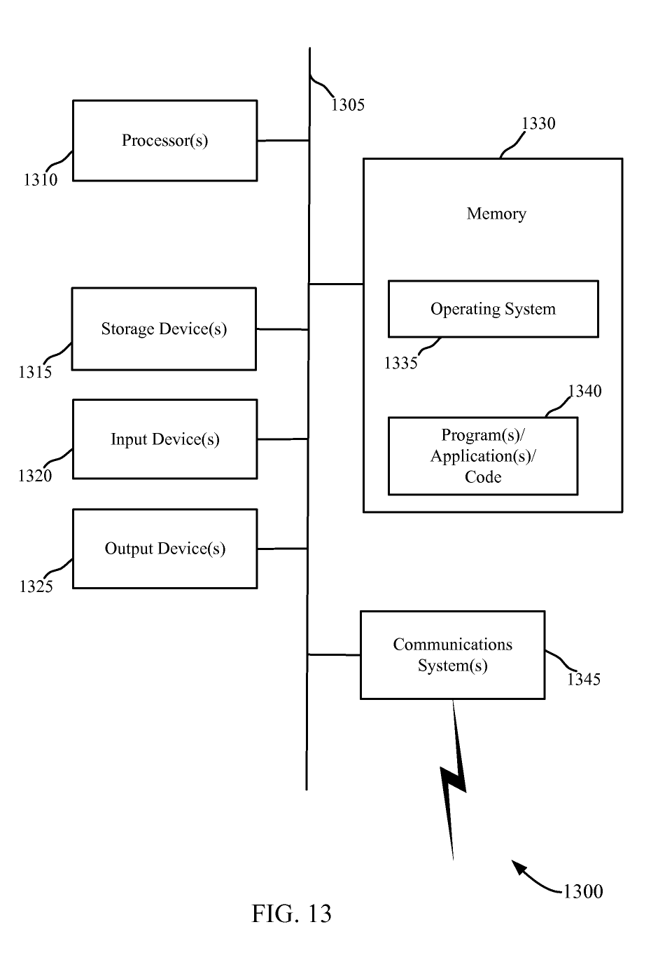

A device structure 1300 that may be used for a point-of-transaction device 105, a transaction information server 110, a transaction authority 115, or other computing devices described herein, is illustrated with the schematic diagram of FIG. 13. This drawing broadly illustrates how individual system elements of each of the aforementioned devices may be implemented, whether in a separated or more integrated manner. The exemplary structure is shown comprised of hardware elements that are electrically coupled via bus 1305, including processor(s) 1310 (which may further comprise a DSP or special-purpose processor), storage device(s) 1315, input device(s) 1320, and output device(s) 1325. The storage device(s) 1315 may be a machine-readable storage media reader connected to any machine-readable storage medium, the combination comprehensively representing remote, local, fixed, or removable storage devices or storage media for temporarily or more permanently containing computer-readable information. The communications systems interface 1345 may interface to a wired, wireless, or other type of interfacing connection that permits data to be exchanged with other devices. The communications system(s) interface 1345 may permit data to be exchanged with a network.

The structure 1200 may also include additional software elements, shown as being currently located within working memory 1330, including an operating system 1335 and other code 1340, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

These components may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of conducting a transaction comprising:
receiving, at a transaction information server, a request for a transaction from a point of transaction device, the request comprising a transaction amount, a customer identifier code, and an identification parameter that is collected from a party to the transaction contemporaneous to the transaction;
authenticating the identification parameter based on a record associated with the customer identifier code stored by the transaction information server;
communicating with a transaction authority to establish a transaction identifier code for the transaction based on the authentication of the identification parameter; and
transmitting the transaction identifier code to the point of transaction device based on the authentication of the identification parameter.

2. The method of claim 1, wherein the transaction comprises a cash-based transaction.

3. The method of claim 1, further comprising:
forwarding at least a portion of the request for the transaction to a plurality of approving authorities in an order associated with a hierarchy of the approving authorities; and
receiving confirmation from a first one of the approving authorities that the identification parameter is associated with the customer identifier code.

4. The method of claim 1, further comprising:
retrieving a second identification parameter from the record associated with the customer identifier code stored by the transaction information server;
returning the second identification parameter to the point of transaction device; and
receiving an indication from the point of transaction device of whether the party to the transaction matches the second identification parameter.

5. The method of claim 4, wherein the communicating with the transaction authority to establish the transaction identifier occurs in response to the point of transaction device indicating that the party to the transaction matches the second identification parameter.

6. The method of claim 1, further comprising:
sending, after authenticating the identification parameter, a temporary identification code to the party to the transaction based on a contact data stored in the record associated with the customer identifier code; and
receiving, at the transaction information server, confirmation that the party to the transaction received the temporary identification code.

7. The method of claim 6, wherein the confirmation that the party to the transaction received the temporary identification code comprises:
receiving the temporary identification code from a second party to the transaction.

8. The method of claim 1, further comprising:
determining whether a record associated with the customer identifier code is stored by the transaction information server; and
creating a new record for the party to the transaction based on the customer identifier code and the identification parameter upon determining that no record associated with the customer identifier code is stored by the transaction information server.

9. The method of claim 1, wherein the identification parameter comprises biometric data captured from the party to the transaction contemporaneous to the transaction.

10. The method of claim 1, wherein the identification parameter comprises an image of an identification document received from the party to the transaction, the image captured contemporaneous to the transaction.

11. The method of claim 1, further comprising:
receiving a registration request before the transaction to pre-register a party to the transaction, the registration request including information associated with a party and identifying the party.

12. A method for conducting a transaction comprising:
transmitting, from a point of transaction device, a request for a transaction to a transaction information server, the request comprising a transaction amount, a customer identifier code, and an identification parameter that is collected from a party to the transaction contemporaneous to the transaction;
receiving, from the transaction information server, a transaction identifier code based on an authentication of the identification parameter;
transmitting the transaction identifier code and at least a portion of the request for the transaction to a transaction authority separate from the transaction information server; and
receiving an approval for the transaction from the transaction authority, the approval based on the transaction identifier code and the request.

13. The method of claim 12, wherein the transaction comprises a cash-based transaction.

14. The method of claim 12, further comprising:
capturing biometric data from the party to the transaction contemporaneous to the transaction.

15. The method of claim 12, further comprising:
capturing an image of an identification document received from the party to the transaction contemporaneous to the transaction;
wherein the identification parameter comprises the captured image of the identification document.

16. The method of claim 12, further comprising:
receiving, from the transaction information server, an image of a customer associated with the customer identifier code; and
transmitting a verification signal to the transaction information server confirming an identity of the party to the transaction based on the image.

17. The method of claim 12, further comprising:
transmitting a temporary identification code, provided by the party to the transaction contemporaneously with the transaction, to the transaction information server before receiving the transaction identifier code.

18. The method of claim 12, wherein the transmission to and receipt from the transaction information server is via a first communications channel and transmission to and receipt from the transaction authority is via a second communications channel.

19. The method of claim 12, wherein the point of transaction device is a mobile communications device.

20. An apparatus for conducting a transaction comprising:
a processor;
a memory in electronic communication with the processor; and
instructions being executable by the processor to,
receive, at a transaction information server, a request for a transaction from a point of transaction device, the request comprising a transaction amount, a customer identifier code, and an identification parameter that is collected from a party to the transaction contemporaneous to the transaction;
authenticate the identification parameter based on a record associated with the customer identifier code stored by the transaction information server;
communicate with a transaction authority to establish a transaction identifier code for the transaction based on the authentication of the identification parameter; and
transmit the transaction identifier code to the point of transaction device based on the authentication of the identification parameter.

21. The apparatus of claim 20, further comprising instructions to:
retrieve a second identification parameter from the record associated with the customer identifier code stored by the transaction information server;
return the second identification parameter to the point of transaction device; and
receive an indication from the point of transaction device of whether the party to the transaction matches the second identification parameter.

22. The apparatus of claim 20, wherein the identification parameter comprises biometric data captured from the party to the transaction contemporaneous to the transaction.

23. The apparatus of claim 20, wherein the identification parameter comprises an image of an identification document received from the party to the transaction, the image captured contemporaneous to the transaction.

24. An apparatus for conducting a transaction comprising:
a processor;
a memory in electronic communication with the processor; and
instructions being executable by the processor to,
transmit, from a point of transaction device, a request for a transaction to a transaction information server, the request comprising a transaction amount, a customer identifier code, and an identification parameter that is collected from a party to the transaction contemporaneous to the transaction;
receive, from the transaction information server, a transaction identifier code based on an authentication of the identification parameter;
transmit the transaction identifier code and at least a portion of the request for the transaction to a transaction authority separate from the transaction information server; and
receive an approval for the transaction from the transaction authority, the approval based on the transaction identifier code and the request.

25. The apparatus of claim 24, further comprising instructions to:
capture an image of an identification document received from the party to the transaction contemporaneous to the transaction;
wherein the identification parameter comprises the captured image of the identification document.

26. The apparatus of claim 24, further comprising instructions to:
receive, from the transaction information server, an image of a customer associated with the customer identifier code; and
transmit a verification signal to the transaction information server confirming an identity of the party to the transaction based on the image.

27. The apparatus of claim 24, further comprising instructions to:
transmit a temporary identification code, provided by the party to the transaction contemporaneously with the transaction, to the transaction information server before receiving the transaction identifier code.

28. A system for conducting a transaction comprising:
a point of transaction device configured to transmit a request for a transaction, the request comprising a transaction amount, a customer identifier code, and an identification parameter that is collected from a party to the transaction contemporaneous to the transaction; and
a transaction information server in communication with the point of transaction device to receive the request, authenticate the identification parameter based on a record associated with the customer identifier code, communicate with a transaction authority to establish a transaction identifier code for the transaction, and transmit the transaction identifier code to the point of transaction device.

29. The system of claim 28, further comprising a secondary point of transaction device configured to transmit the transaction identifier code and at least a portion of the request for the transaction to a transaction authority separate from the transaction information server to receive an approval of the transaction.

30. The system of claim 29, wherein the point of transaction device communicates with the transaction information server via a first communications channel and the secondary point of transaction device communicates with the transaction authority via a second communications channel.

31. The system of claim 28, wherein the identification parameter comprises a biometric data and the point of transaction device further comprises:
a biometric capture device configured to capture the biometric data from a party to the transaction contemporaneous to the transaction.
